(19) United States
(12) Patent Application Publication
(10) Pub. No.: US 2009/0125841 A1
(43) Pub. Date: May 14, 2009

(54) OPERATION PANEL AND ELECTRIC DEVICE INCLUDING THE SAME

(76) Inventor: Tomohito YAMASHITA, Nara (JP)

Correspondence Address: MARK D. SARALINO ( SHARP );RENNER, OTTO, BOISSELLE & SKLAR, LLP, 1621 EUCLID AVENUE, 19TH FLOOR, CLEVELAND, OH, 44115, US

(21) Appl. No.: 12/268,525

(22) Filed: Nov. 11, 2008

(30) Foreign Application Priority Data
Nov. 13, 2007 (JP) 2007-294803

(51) Int. Cl. G06F 3/048

(52) U.S. Cl. 715/810

(57) ABSTRACT

The present invention provides an operation panel 13 that makes it easier to select setting buttons 20c and 20e desired by a user and to perform setting of various kinds of processings, and an electric device including the same.

The operation panel 13 provided in an image processing apparatus 1 includes an operation section 13a for inputting an operation instruction, a display section 13b for displaying an operation screen, a control section 13c for causing the display section 13b to display a different operation screen every time setting buttons 20c and 20e in the operation screen are operated, and a storage section 13d for storing the selected setting button 20c. The control section 13c counts the number of use times of each setting button 20c to store in the storage section 13d. When a setting screen is displayed, the control section 13c detects the number of use times of each of the setting buttons 20c to change a display state on the display section 13b depending on the number of use times.

With the structure above, even when many setting buttons 20c and 20e are displayed on the setting screen for various kinds of processings, the desired setting button 20c can be selected easily.

### BACKGROUND OF THE INVENTION

1. Field of the Invention

The present invention relates to an operation panel that changes a display of a setting button on an operation screen and an electric device including the same.

2. Description of the Related Art

A current image processing apparatus has various output processing functions such as a staple processing and a punch processing. In order to execute these output processing functions, a user needs to input operation instruction into a plurality of operation screens. However, it takes time and labor to input the operation instruction into a plurality of operation screens.

Hence, there is disclosed in Japanese Patent Laid-Open No. 2005-242922 that a frequency calculating section calculates a selection frequency of a selection button for each operation, a setting section sets a setting button having the highest selection frequency thus calculated as an operation at the time of image formation, a control section changes a color of the setting button that has been set, and after processing of changing the color of the setting button, the control section displays the setting button in the changed color.

In the Japanese Patent Laid-Open No. 2005-242922, when shifted to an operation screen, setting of the selection button is automatically performed based on a usage frequency in the past. Therefore, there is a problem that an unaccustomed user, without noticing that setting of the selection button has been already made, performs processing with wrong setting.

In view of the above described circumstance, it is an object of the present invention to provide an operation panel that makes it easier to select a setting button desired by a user and to perform setting for various processes, and an electric device including the same.

### SUMMARY OF THE INVENTION

In order to achieve the above described object, the present invention provides an operation panel for operating a setting button on an operation screen to input operation instruction, including a display section for displaying the operation screen, and a control section for causing the display section to display the operation screen, wherein the control section selects a setting button that is desired to be displayed differently from other setting buttons depending on a usage frequency to change a display of the selected setting button.

A user selects, among a plurality of setting buttons, a setting button that is desirably displayed differently from other setting buttons, that is, a setting button that is desirably displayed more prominently than other setting buttons. The control section counts the number of use times of the selected setting button. The control section changes a display of the selected setting button based on the measuring result. For example, as the counted number of use times increases, the control section changes the display of the selected setting button in a stepwise manner.

According to the above described structure, depending on the usage frequency of the user, the display of the selected setting button is differentiated from that of the other setting buttons, thus the user is able to recognize the frequently used setting button at a glance. As a result, the user is able to perform the selection of the desired setting button easily.

An example of a method for changing the display includes a method for changing a display color, a display size, and a display blinking speed, or a display vibration period of the setting button.

The operation panel includes an input section for inputting operation instruction. The input section has a selection button for selecting the method for changing the display of the setting button desired to be displayed more prominently than other setting buttons. Upon detection of that the selection button has been operated, the control section displays a selection screen for selecting the method for changing the display of the setting button.

The control section customizes the selected setting button and change of the display for each user. According to this structure, it is possible to change a setting button desired to be displayed more prominently for each user. Furthermore, it is also possible to change a method for changing a display thereof for each user. That is, depending on user's preference, it is possible to display a setting button that is desirably displayed differently.

The above described operation panel is provided in an electric device. The electric device includes, for example, a copier, a printer, a facsimile, a scanner, or a multifunctional peripheral combining two or more of them.

As described above, according to the present invention, the display of the setting button that is frequently used is made differently from those of the other setting buttons, thus making it possible to recognize the setting button for a desired function that is desirably set at a glance. Thereby, when performing various settings on the operation screen, the user is able to select the selection button easily. As a result, user's labor for searching the setting button to call up the desired operation screen is eliminated, thus making it possible to reduce the time for setting.

### BRIEF DESCRIPTION OF THE DRAWINGS

FIG. 1 is a perspective view showing an image processing apparatus according to the present embodiment;

FIG. 2 is a sectional view showing the image processing apparatus;

FIG. 3 is a block diagram of the image processing apparatus;

FIG. 4 is an elevation view showing an operation panel used in an image forming apparatus;

FIG. 5 is a view showing an initial screen;

FIG. 6 is a view of an operation screen showing a state before setting buttons are changed;

FIG. 7 is a view showing a state after setting buttons are changed from the state of FIG. 6;

FIG. 8 is a view showing a state after setting button are changed from the state of FIG. 7;

FIG. 9 is a flowchart showing an operation in the operation panel; and

FIG. 10 is a view showing an example of a table stored in a storage section.

### DETAILED DESCRIPTION OF THE PREFERRED EMBODIMENTS

An operation panel 13 of the present invention will hereinafter be described in detail. For the sake of easy explanation, a case where the operation panel 13 is mounted on an electric device having a copy mode, a print mode, a scan mode, and a facsimile mode, specifically, on an image processing apparatus 1, will be used for explanation.

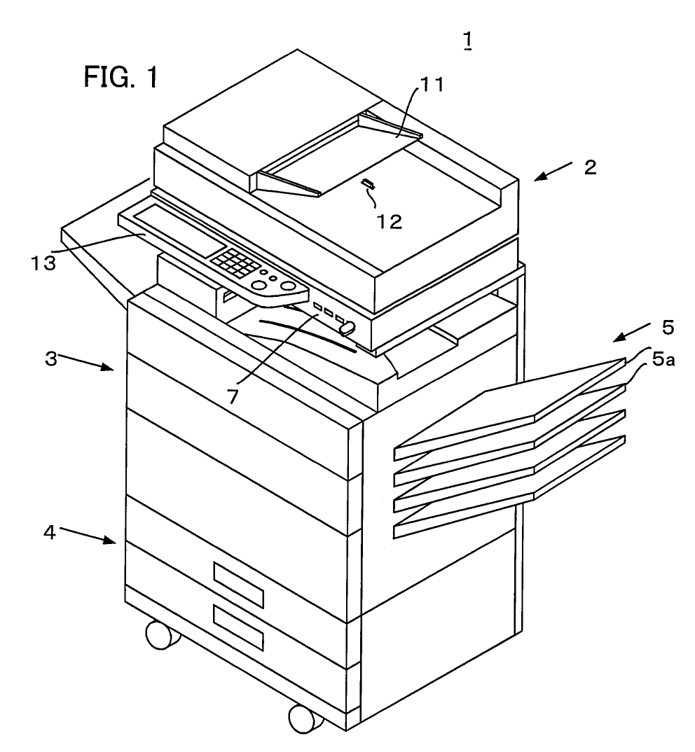

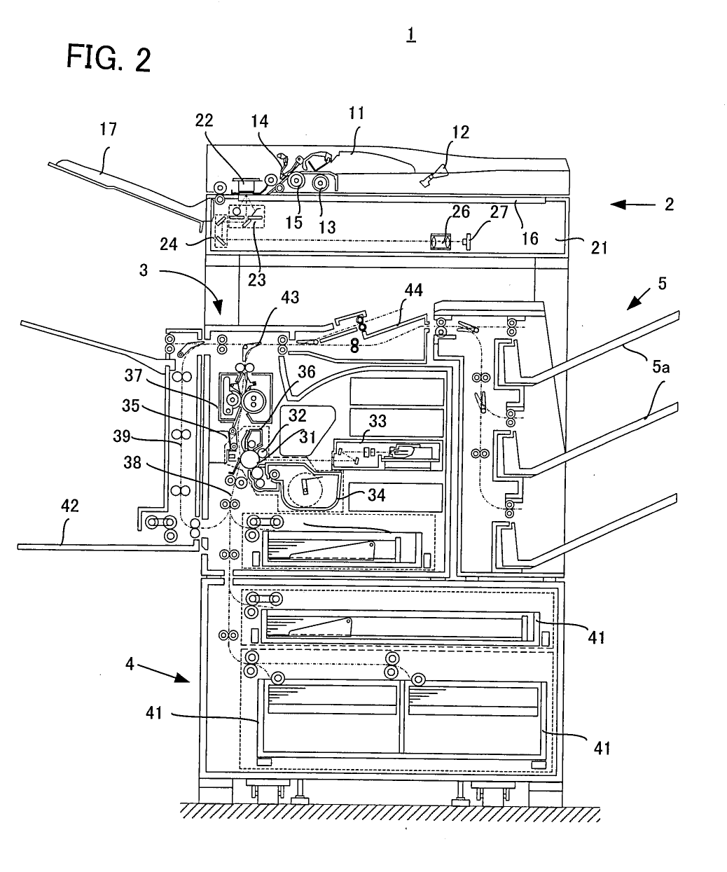

As shown in FIGS. 1 to 3, the image processing apparatus 1 can be selectively operated in a copy mode in which an image of a document is read and printed on a recording paper, a facsimile mode in which an image of a document is read and transmitted or an image of a document is received and printed on a recording paper, a print mode in which an image received through a network from an information terminal device is printed on a recording paper, or the like.

The image processing apparatus 1 includes a document conveyance/reading section 2, an image forming section 3, a paper feed section 4, a paper ejection processing apparatus 5, and a USB interface 7.

Next, an operation of the image processing apparatus 1 will be described, illustrating the copy mode.

First, when a document is set in a document set tray 11 of the document conveyance/reading section 2, a document detection sensor 12 detects that the document has been set. Thereafter, by operating the operation panel 13 of the document conveyance/reading section 2, a size of a printing paper, an enlargement/reduction ratio, and the like are set to be inputted. Then, start of copying is commanded by operating the operation panel 13.

In response to these operations, the document conveyance/reading section 2 pulls out documents one by one from the document set tray 11 by a pick-up roller 18, delivers the document through between a document separation plate 14 and a transport roller 15 to a platen glass 16, transports the document in a vertical scanning direction on the platen glass 16, and discharges the document to a document ejection tray 17.

At this time, a surface (a lower side surface) of the document is read by a first reading section 21. A first scanning unit 23 of the first reading section 21 is shifted to a position to be positioned and a second scanning unit 24 is positioned in a predetermined position. Then, the surface of the document is irradiated with an exposure lamp of the first scanning unit 23 through the platen glass 16, reflected lights from the document are led to an imaging lens 26 by respective reflecting mirrors of the first and second scanning units 23 and 24, the reflected lights from the document are collected onto a CCD (charge coupled device) 27 by the imaging lens 26, and an image on the surface of the document is formed on the CCD 27. Thereby, the image on the surface of the document is read.

A rear surface (an upper side surface) of the document is read by a second reading section 22. The second reading section 22 is arranged above the platen glass 16, and includes an exposure lamp (an LED array, a fluorescent lamp, or the like) for irradiating the rear surface of the document, a Selfoc lens array for collecting reflected lights from the document depending on the number of pixels, a contact image sensor (CIS) for photoelectrically converting the reflected lights from the document received through the Selfoc lens array and outputting an analog image signal, and the like.

In the document conveyance/reading section 2, it is possible that an upper housing thereof is opened so that the surface of the document is read by the first reading section 21 in a state where the document is placed on the platen glass 16. In this case, the first and second scanning units 23 and 24 are shifted in the vertical scanning direction while maintaining a predetermined speed relation therebetween, the document on the platen glass 16 is exposed to light by the first scanning unit 23, and after reflected lights from the document are led to the imaging lens 26 by the first and second scanning units 23 and 24, the image of the document is formed on the CCD 27 by the imaging lens 26.

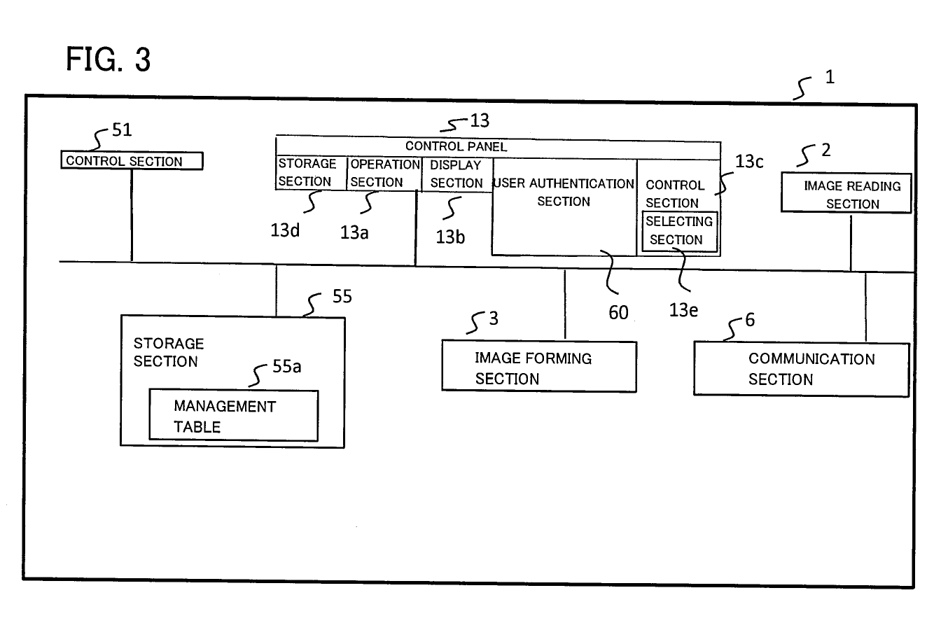

In this way, when one side or both sides of the document are read, an image data showing an image or images on the one side or both sides of the document is inputted into a control section 51 (refer to FIG. 3) such as a micro computer. Here, various image processes are applied to the image data and this image data is outputted to the image forming section 3.

The image forming section 3 prints the image of the document indicated by the image data onto a recording paper, and includes a photoreceptor drum 31, a charging apparatus 32, a laser scanning unit (hereinafter referred to as an LSU) 33, a development apparatus 34, a transfer apparatus 35, a cleaning apparatus 36, a charge removal apparatus (not shown) a fixing apparatus 37, and the like.

The image forming section 3 is provided with a main conveyance path 38 and a reversing conveyance path 39, and a recording paper fed from the paper feed section 4 is transported along the main conveyance path 38. The paper feed section 4 pulls out recording papers stored in a paper cassette 41 or recording papers placed on a manual tray 42 one by one to deliver the recording paper to the main conveyance path 38 of the image forming section 3.

While the recording paper is transported along the main conveyance path 38 of the image forming section 3, the recording paper passes through between the photoreceptor drum 31 and the transfer apparatus 35, and then passes through the fixing apparatus 37, followed by printing on the recording paper.

The photoreceptor drum 31 is rotated in one direction, and after the surface thereof is cleaned by the cleaning apparatus 36 and the charge removal apparatus, the surface is charged uniformly by the charging apparatus 32.

The laser scanning unit 33 modulates laser light based on the image data from the document=conveyance/reading section 2, and repeatedly scans the surface of the photoreceptor drum 31 in a main scanning direction with this laser light, to form a static latent image on the surface of the photoreceptor drum 31.

The development apparatus 34 supplies toner to the surface of the photoreceptor drum 31 and develops the static latent image to form a toner image on the surface of the photoreceptor drum 31.

The transfer apparatus 35 transfers the toner image on the surface of the photoreceptor drum 31 onto the recording paper passing through between the transfer apparatus 35 and the photoreceptor drum 31. The fixing apparatus 37 heats and pressurizes the recording paper to fix the toner image onto the recording paper.

A branch pawl 43 is arranged at a connecting position of the main conveyance path 38 and the reversing conveyance path 39. When printing is made only on one side of the recording paper, the branch pawl 43 is positioned, and the recording paper from the fixing apparatus 37 is led to a paper ejection tray 44 or the paper ejection processing apparatus 5 by this branch pawl 43.

When printing is made on both sides of the recording paper, the branch pawl 43 is rotationally moved to a position indicated by dashed line, and the recording paper is led to the reversing conveyance path 39. Then, the recording paper passes through the reversing conveyance path 39 to be turned upside down and transported again to the main conveyance path 38, and during this second transportation to the main conveyance path 38, printing is made on the rear surface of the recording paper and the recording paper is then led to the ejection tray 44 or the ejection processing apparatus 5.

The recording paper subjected to printing in this way is led to the ejection tray 44 or the ejection processing apparatus 5, and then is ejected to either the paper ejection tray 44 or any of the ejection trays 5a of the ejection processing apparatus 5.

In the paper ejection processing apparatus 5, a plurality of recording papers are sorted and ejected to the respective ejection trays 5a, each of the ejected recording papers being subjected to a punch processing, or each of the recording papers being subjected to a staple processing. For example, when multiple copies of printed matters are created, the paper ejection processing apparatus 5 sorts and ejects a plurality of recording papers to the respective paper ejection trays 5a so that one copy of printed matter is allocated to each of the paper ejection trays 5a, and for each paper ejection tray 5a, applies a punch processing or a staple processing to the respective recording papers on the paper ejection trays 5a to create printed matters.

In the meantime, when performing processings of copy, print, scan, and facsimile, a user can set a special function such as a margin shift and an edgeerase. On an operation screen for setting the specific function, many setting buttons 20c and 20e are displayed.

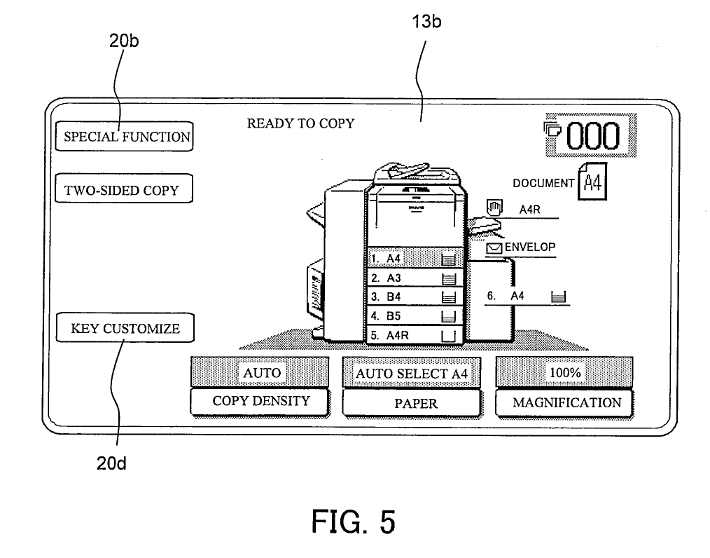

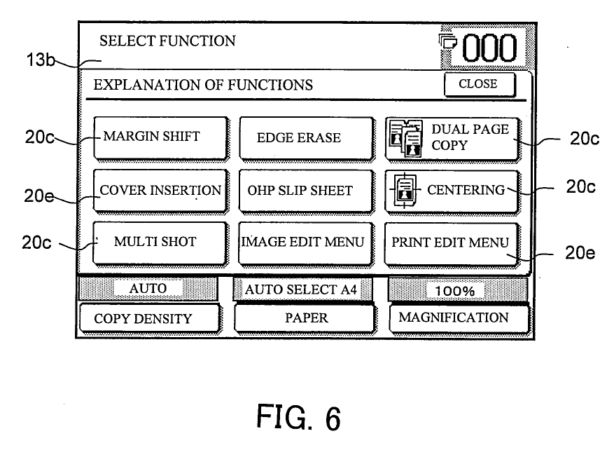

For example, when a touch button 20b of the special function shown in FIG. 5 is operated, an operation screen as shown in FIG. 6 is displayed. On the operation screen, a plurality of setting buttons 20c and 20e including margin shift, edge erase, dual page copy, cover insertion, OHP insertion, centering, multi shot, image edit menu, and print edit menu, are displayed. These setting buttons 20c and 20e are displayed in a similar form. Therefore, it takes time for a user to select desired setting buttons 20c and 20e.

Hence, in order to improve operability for the user, the operation panel 13 has a display function of displaying the setting button 20c displayed on a display portion 13b differently from other setting buttons 20e depending on a usage frequency.

Specifically, the operation panel 13 has a function of selecting, among the plurality of setting buttons 20c and 20e, the setting button 20c desired to be displayed differently from other setting buttons 20e, and, based on the usage frequency of the selected setting button 20c, changing a display of the selected setting button 20c in a stepwise manner. Thereby, user's labor for searching the setting button 20c to call up an operation screen for setting a desired special function is eliminated, thus making it possible to reduce the time for setting functions.

Next, the operation panel 13 for realizing the display function will be described.

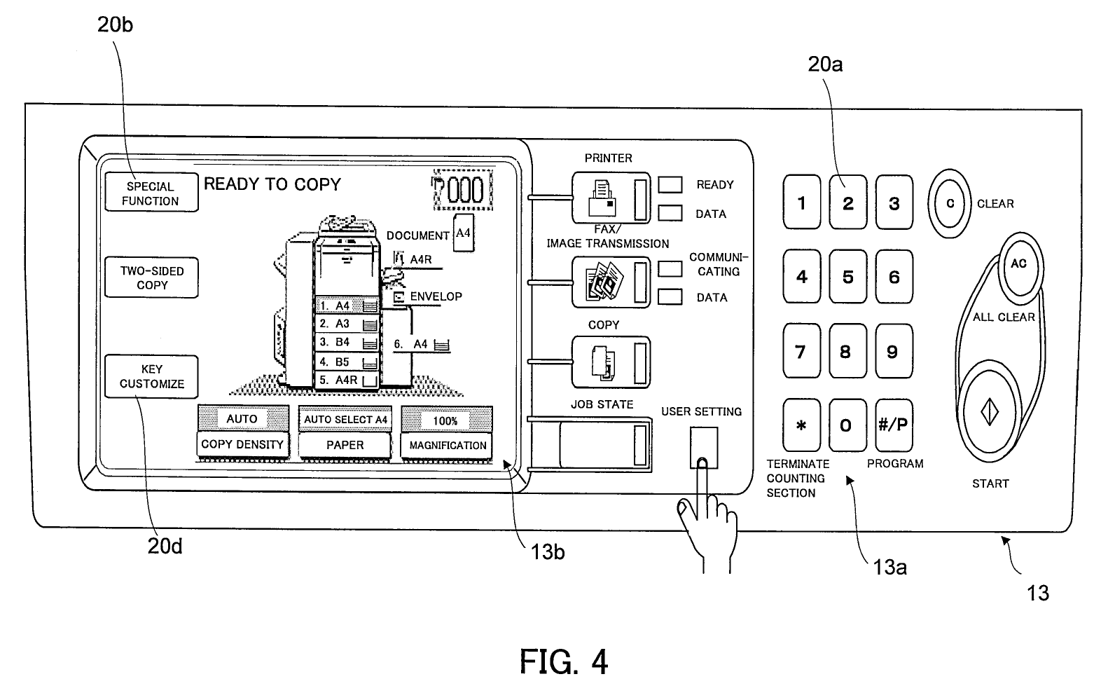

As shown in FIG. 4, the operation panel 13 includes an operation section 13a for inputting operation instruction, the display section 13b for displaying an operation screen, a control section 13c for controlling the display section 13b, and a storage section 13d for storing the selected setting button 20c.

Here, the operation screen refers to a screen on which display contents necessary for forming the screen and input contents of the operation instruction are displayed. Moreover, the setting buttons 20c and 20e are buttons that are operated to call up the operation screen for setting various kinds of special functions.

The operation section 13a includes a mechanical hard button 20a used for input. The display section 13b includes a screen and a driving section for driving and controlling the screen. The screen has a known touch panel and is formed with the touch button 20b for operating input.

The storage section 13d is a readable and writable semiconductor memory such as an SDRAM and a flash memory. The storage section 13d stores the setting button 20c selected by a user, that is, the setting button 20c desired to be displayed differently from other setting buttons 20e.

The storage section 13d stores selected buttons for each user. Specifically, the operation panel 13 includes a user authenticating section 60 for identifying a user. When a user's finger touches the touch panel, the user authenticating section 60 identifies the user by the fingerprint of the user, but without limitation thereto, by registering in advance ID information in a contact or non-contact memory such as a USB, the user authenticating section 60 may acquire ID information from the memory.

The storage section 13d stores management information of the selected setting button 20c. The management information includes the number of use times of the setting button 20c and a method for changing a display.

When input from the hard button 20a or the touch button 20b or input from an external device is made, the control section 13c controls each section based on information, which is stored in a memory (not shown), such as control information and setting information in the entire apparatus. That is, the control section 13c starts any one of operations including a copy mode, a print mode, a scan mode, and a facsimile mode, in response to input contents.

The control section 13c causes the display section 13b to display a different operation screen every time the setting buttons 20c and 20e on the operation screen are operated.

The control section 13c includes a selecting section 13e for selecting the setting buttons 20c and 20e desired to be displayed differently from other setting buttons. The selecting section 13e displays a selection button 20d for selecting a method for changing the display of the setting button 20c so as to be displayed differently from other setting buttons 20e on the display section 13b. Upon detection of that the displayed selection button 20d has been operated, the selecting section 13e controls the driving section so as to display a selection screen for selecting a method for changing the display of the setting button 20c on the display section 13b. When the selection button 20d is not operated, the selecting section 13e does not allow to display the selection screen for selecting a method for changing the display of the setting button 20c.

When the selection screen for selecting a method for changing the display of the setting button 20c is displayed, the user selects the setting button 20c desired to be displayed differently from other setting buttons 20e, from the selection screen displayed on the display section 13b. The selecting section 13e selects a method for changing the display of the selected setting button 20c. When setting is completed, the selecting section 13e causes the storage section 13d to store the selected setting button 20c and the method for changing the display in association with each other.

Note that, as the method for changing the display, a color, a size, a shape, a blink rate, a vibration speed, and the like of the display of the setting button 20c are considered to be changed. For example, in the case of the color, values of a hue, a vividness, and a brightness are increased in a stepwise manner. In the case of the size, the size of the selected setting button 20c is changed so as to be relatively larger than those of other setting buttons 20e. In the case of the shape, the shape of the selected setting button 20c is changed so as to be a polygonal shape close to a circular shape. In the case of the blink rate, the selected setting button 20c is changed so as to blink quickly or slowly. In the case of the vibration speed, the selected setting button 20c is changed so as to vibrate quickly or slowly.

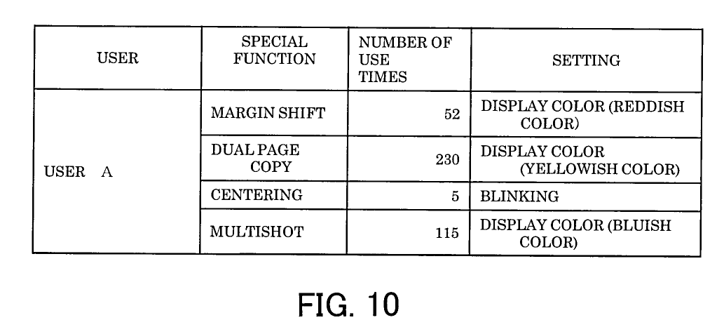

As shown in FIG. 10, the selecting section 13e creates a table for each user to store in the storage section 13d. A user A in FIG. 10 is the user who has set a display function. The selected buttons 20c include margin shift, dual page copy, centering, and multi shot. In addition, the method for changing the display is such that the display color is changed in margin shift, dual page copy, and multi shot, and the blink rate of the display is changed in centering, so as to differentiate the display from those of other setting buttons 20e.

The control section 13c counts the number of use times of the selected setting buttons 20c and updates the number of use times in the table (refer to FIG. 10).

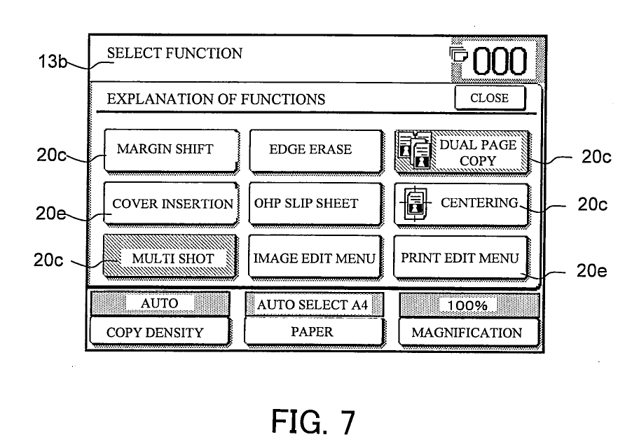

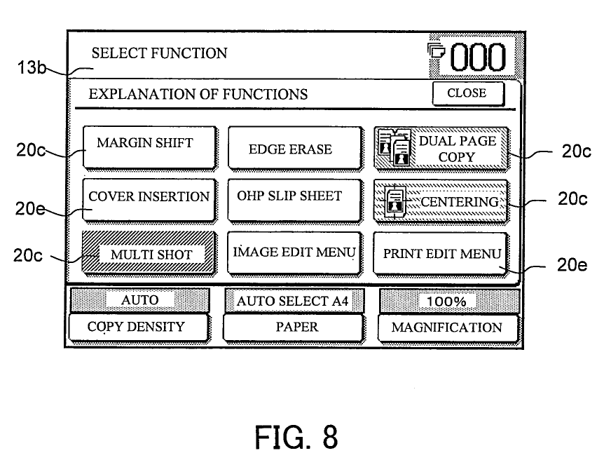

The control section 13c changes the display of the setting buttons 20c in a stepwise manner depending on the counted times. For example, like the setting in the table shown in FIG. 10, when changing the display of the selected setting buttons 20c of dual page copy and multi shot that are selected, the display of the selected setting buttons 20c of dual page copy and multi shot that have been displayed in the same form as that of other setting buttons 20c and 20e is changed in a stepwise manner, as shown in FIGS. 7 and 8, as the number of use times of the setting buttons 20c of dual page copy and multi shot is increased.

For example, when changing the display color, values of a hue, a vividness, and a brightness are changed by one point or by a plurality of points. When changing the display shape, the display shape of the setting buttons 20c is changed by a corner or by a plurality of corners. When changing the blink rate of the display, a value of the blink rate of the setting buttons 20c is changed by one point or by a plurality of points. When changing the vibration speed of the display, a value of the vibration speed is changed by one point or by a plurality of points.

Here, the timing when the display of the setting buttons 20c is changed is set by the user in advance. For example, the control section 13c changes the display of the setting buttons 20c every time the number of use times of the selected setting buttons 20c is counted once. Alternatively, the control section 13c changes the display of the setting buttons 20c every time the usage times of the selected setting buttons 20c is counted predetermined times, for example, ten times or twenty times.

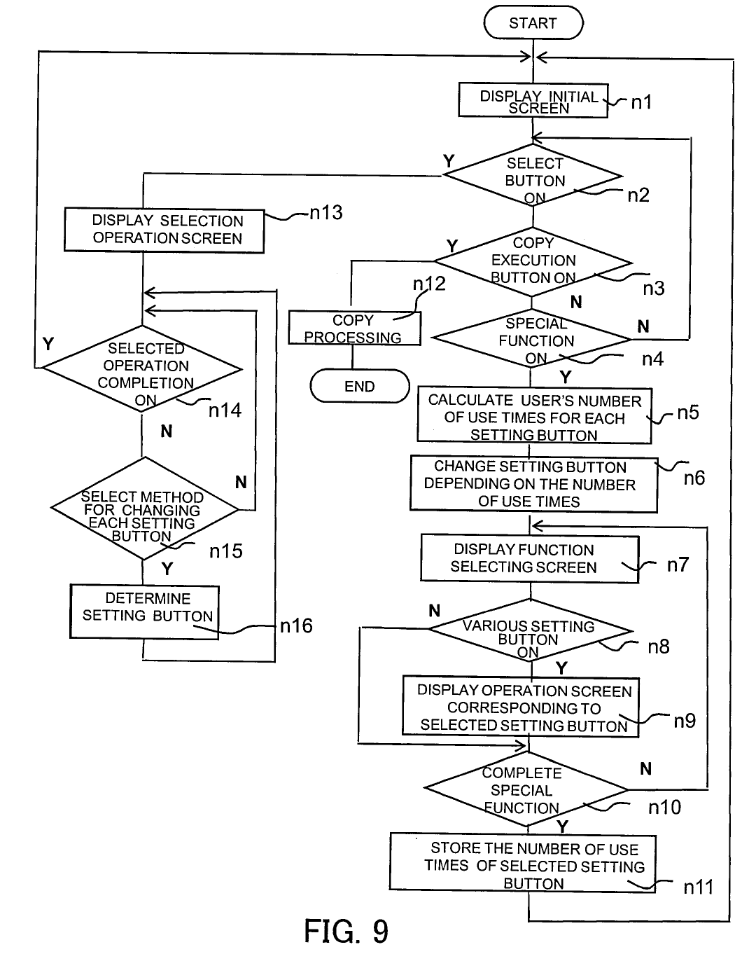

Next, taking a copy mode as an example, the operation of the display function of the operation panel 13 will be described with reference to the flowchart of FIG. 9.

First, description will be given for an operation to select the setting button 20c desired to be displayed differently and to determine a method for changing a display thereof.

When a user turns the power on, the control section 13c controls the driving section so as to display an initial screen on the display section 13b. When the user selects a copy mode, then an initial screen for the copy mode as shown in FIG. 5 is displayed (n1). In the initial screen for the copy mode, when the user operates a key customize button which is the selection button 20d (“Yes” at n2), the selecting section 13e causes the display section 13b to display a selection screen for selecting a method for changing the display of setting button 20c (n13).

When an operation to complete setting of the display function is not performed (“No” at n11) but an operation to select a method for changing the display of the setting button 20c is performed by the user (“Yes” at n15), the selecting section 13e creates a table in which setting of the method for changing the display of the selected setting button 20c is stored, and stores the table in the storage section 13d (n16). When the operation to complete setting of the display function is performed by the user (“Yes” at n14), the control section 13c displays the initial screen again (n1).

Next, description will be given for an operation to change the display of the selected setting button 20c and determine a process.

When the user does not operate the key customize button 20d (“No” at n2) but operates an execution button of a copy processing (“Yes” at n3), the control section 13c executes the copy processing under the set conditions (n12). When the processing is completed, the control section 13c causes the display section 13b to display the initial screen.

When the execution button of the copy process is not operated (“No” at n3) but the special function button 20d is operated (“Yes” at n8), the control section 13c reads the number of use times of the selected setting button 20c from the table (n5). Depending on the number of use times, processing of changing the display of the setting button 20c is performed (n6). The control section 13c then controls the driving section so as to display the changed setting button 20c on the display section 13b (n7).

When the user operates any of the setting buttons 20c and 20e (“Yes” at n8), the control section 13c causes the display section 13b to display an operation screen corresponding to the operated setting buttons 20c and 20e (n9). When operation instruction is inputted into the operation screen, the control section 13c confirms whether or not an operation to complete setting is performed (n10). When the operation to complete setting is not performed (“No” at n10), the control section 13c confirms whether or not any of the setting buttons 20c and 20e is operated (n8). When the setting buttons 20c and 20e are not operated (“No” at n8), whether or not the operation to complete setting is performed is confirmed (n10). The control section 13c performs processes from n8 to n10 repeatedly until the operation to complete setting is performed.

When the user performs the operation to complete setting (“Yes” at n10), the initial screen is displayed on the display section 13b. At this time, the control section 13c counts up the number of use times of the selected setting button 20c during setting of the special function and stores the number of use times in the storage section 13d (n11). Then, the control section 13c confirms whether or not the key customize button 20d is operated (n2).

When the key customize button 20d is operated (“Yes” at n2), the processings from n13 to n16 are performed. When the key customize button 20d is not operated (“No” at n2), whether or not the execution button of the copy processing is operated is confirmed (n3). When the user operates the execution button (“Yes” at n3), the control section 13c executes the copy processing under the set conditions (n12). When the processing is completed, the control section 13c causes the display section 13b to display the initial screen. The control section 13c performs the processes from n2 to n11 repeatedly until the operation of the copy processing is performed.

As a result, even when a plurality of setting buttons 20c and 20e to call up an operation screen for setting various kinds of special functions are displayed, the desired setting button 20c can be selected easily, thus making it possible to reduce the setting time.

The present invention will not be limited to above described embodiments and many modifications and alterations can certainly be made to the above described embodiments within the scope of the present invention. In the present embodiment, description has been given with reference to the copy mode, however, it may be a filing mode or a FAX mode.

In the present embodiment, description has been made assuming that the electric device is an image processing apparatus, but without limitation thereto, electric devices having an operation screen to set various kinds of functions, such as a washing machine, a microwave oven, and an air conditioner, are also applicable.

In the present embodiment, description has been made assuming that the selection button is a touch button, but without limitation thereto, it may be provided as a hard button.

In the present embodiment, the display of a selected setting button is changed, however, the display of all setting buttons may be changed. For example, a relative usage frequency is detected so that the display is changed depending on the usage frequency.

The display function may be set not for each user but for each electric device. Alternatively, it may be set for each department or each area.

What is claimed is:

1. An operation panel for operating a setting button on an operation screen to input operation instruction, comprising:
a display section for displaying the operation screen; and
a control section for causing the display section to display the operation screen, wherein
the control section selects a setting button desired to be displayed differently from other setting buttons depending on a usage frequency, and changes a display of the selected setting button.

2. The operation panel according to claim 1, wherein:
the control section counts the number of use times of the setting button and changes the display of the setting button in a stepwise manner as the usage times increases.

3. The operation panel according to claim 1, wherein:
the control section changes a color of the display of the setting button.

4. The operation panel according to claim 1, wherein:
the control section changes a size of the display of the setting button.

5. The operation panel according to claim 1, wherein:
the control section changes a blink rate of the display of the setting button.

6. The operation panel according to claim 1, wherein:
the control section changes a vibration period of the display of the setting button.

7. The operation panel according to claim 1 comprising a selection button for selecting a method for changing the display of the setting button, wherein:
when detecting that the selection button is operated, the control section causes the display section to display a selection screen for selecting the method for changing the display of the setting button.

8. The operation panel according to claim 1, wherein:
the control section acquires information for each user and customizes a selected setting button and change of a display for each user.

9. An electric device which is mounted with the operation panel according to claim 1.

10. The electric device according to claim 9, wherein:
the electric device is a copier, a printer, a facsimile, a scanner, or a multifunctional peripheral combining two or more of them.
